(19) United States
(12) Patent Application Publication
(10) Pub. No.: US 2026/0280053 A1
(43) Pub. Date: Sep. 17, 2026

(54) ALL-SOLID-STATE BATTERY AND MANUFACTURING METHOD THEREFOR

(71) Applicant: NISSAN MOTOR CO., LTD., Yokohama-shi, Kanagawa (JP)

(72) Inventors: Yuko TAMURA, Kanagawa (JP); Yoshitaka ONO, Kanagawa (JP)

(73) Assignee: NISSAN MOTOR CO., LTD., Yokohama-shi, Kanagawa (JP)

(21) Appl. No.: 19/473,615

(22) PCT Filed: Apr. 10, 2023
(86) PCT No.: PCT/JP2023/014566

§ 371 Date: Oct. 8, 2025

(51) Int. Cl. H01M 50/477; H01M 10/0525; H01M 10/0562; H01M 10/0585; H01M 50/474

(52) U.S. Cl. CPC H01M 50/477; H01M 10/0525; H01M 10/0562; H01M 10/0585; H01M 50/474; H01M 2300/0068

(57) ABSTRACT

This all-solid-state battery comprises an insulating support frame disposed on a positive electrode current collector foil so as to surround a positive electrode active material layer. The insulating support frame has a first side and a second side that are inclined, and a third side and a fourth side that are inclined to a lesser degree than the first side and the second side. The Young's modulus of the first side is smaller than the Young's moduli of the third side and the fourth side.

### DESCRIPTION

### Technical Field

The present invention relates to an all-solid-state battery and a manufacturing method therefor.

### Background Art

An all-solid-state battery is a secondary battery in which substantially all portions including an electrolyte are formed of a solid material. The all-solid-state battery generally has a configuration in which a positive electrode current collector foil, a positive electrode active material layer, a solid electrolyte layer, a negative electrode active material layer, and a negative electrode current collector foil are laminated in this order.

An all-solid-state battery in which an insulating support frame is provided to surround a positive electrode active material layer is known. An example of such an all-solid-state battery is described in Patent Literature 1 (JP2021-077644A). Patent Literature 1 describes an all-solid-state secondary battery including a positive electrode layer, a negative electrode layer, and a solid electrolyte layer disposed between the positive electrode layer and the negative electrode layer, in which the positive electrode layer includes a positive electrode current collector, a positive electrode active material layer disposed on the positive electrode current collector, and an inert member disposed on at least one side surface of the positive electrode active material layer, and the negative electrode layer includes a negative electrode current collector and a first negative electrode active material layer disposed on the negative electrode current collector.

### SUMMARY OF INVENTION

When an all-solid-state battery is manufactured, roll pressing may be performed from the viewpoint of productivity. When an all-solid-state battery having an insulating support frame is manufactured, first, a positive electrode active material layer and an insulating support frame are formed on a positive electrode current collector foil. Thereafter, the obtained laminate is roll-pressed. When a Young's modulus of the insulating support frame is large, an excessive load is applied to the insulating support frame at a press starting position in the roll pressing, and the insulating support frame may be damaged. On the other hand, when the Young's modulus of the insulating support frame is small, waviness may occur at a boundary between the positive electrode active material layer and the insulating support frame.

Therefore, an object of the present invention is to provide an all-solid-state battery capable of preventing damage and waviness caused by roll pressing, and a manufacturing method therefor.

In one aspect of the present invention, an all-solid-state battery includes: a positive electrode current collector foil; a positive electrode active material layer disposed on the positive electrode current collector foil; a solid electrolyte layer disposed on the positive electrode active material layer; a negative electrode active material layer or a negative electrode current collector foil disposed on the solid electrolyte layer; and an insulating support frame disposed on the positive electrode current collector foil so as to surround the positive electrode active material layer. The insulating support frame has a first side and a second side facing each other, the first side and the second side each having an inclination such that a thickness thereof decreases toward an outside, and a third side and a fourth side each configured to connect the first side and the second side, the third side and the fourth side having a smaller inclination angle than the first side and the second side. A Young's modulus of the first side is smaller than Young's modulus of the third side and the fourth side.

In another aspect of the present invention, a method for manufacturing an all-solid-state battery includes: a step of forming a positive electrode active material layer on a positive electrode current collector foil; a step of forming an insulating support frame surrounding the positive electrode active material layer on the positive electrode current collector foil to produce a positive electrode structure including the positive electrode current collector foil, the positive electrode active material layer, and the insulating support frame; and a step of pressing the positive electrode structure by roll pressing. The insulating support frame has a first side and a second side facing each other, and a third side and a fourth side each configured to connect the first side and the second side. A Young's modulus of the first side is smaller than Young's modulus of the third side and the fourth side. The pressing step includes a step of performing roll pressing such that pressing is started on the first side and the pressing is ended on the second side.

### BRIEF DESCRIPTION OF DRAWINGS

FIG. 1 is a schematic cross-sectional view illustrating a main part of an all-solid-state battery according to an embodiment.

FIG. 2 is a plan view illustrating a positive electrode active material layer and an insulating support frame.

FIG. 3A is a cross-sectional view taken along a line AA of FIG. 2.

FIG. 3B is a cross-sectional view taken along a line BB in FIG. 2.

FIG. 4 is a diagram schematically illustrating a method for manufacturing an all-solid-state battery.

FIG. 5 is a schematic diagram illustrating a roll pressing step.

FIG. 6 is a graph illustrating a relationship between a conveyance position and a load when a Young's modulus of a first side is large.

FIG. 7 is a graph illustrating the relationship between the conveyance position and the load when the Young's modulus of the first side is small.

FIG. 8 is a schematic diagram illustrating a waviness generation mechanism.

FIG. 9 is a plan view illustrating a waviness generation position.

FIG. 10 is a schematic diagram illustrating an example of a step of producing the insulating support frame.

FIG. 11 is a schematic cross-sectional view illustrating a modification of the embodiment.

FIG. 12 is a schematic diagram illustrating a slipping mechanism of an end of a solid electrolyte layer.

### DESCRIPTION OF EMBODIMENTS

Hereinafter, an embodiment of the present invention will be described with reference to the drawings.

In the present specification, an “all-solid-state battery” is a secondary battery using a solid electrolyte layer. However, an electrolyte in the solid electrolyte layer is mainly a solid electrolyte, but may include a small amount of liquid electrolyte. When a positive electrode layer and a negative electrode layer contain an electrolyte, similarly, a main component thereof is a solid electrolyte, but a small amount of liquid electrolyte may be contained.

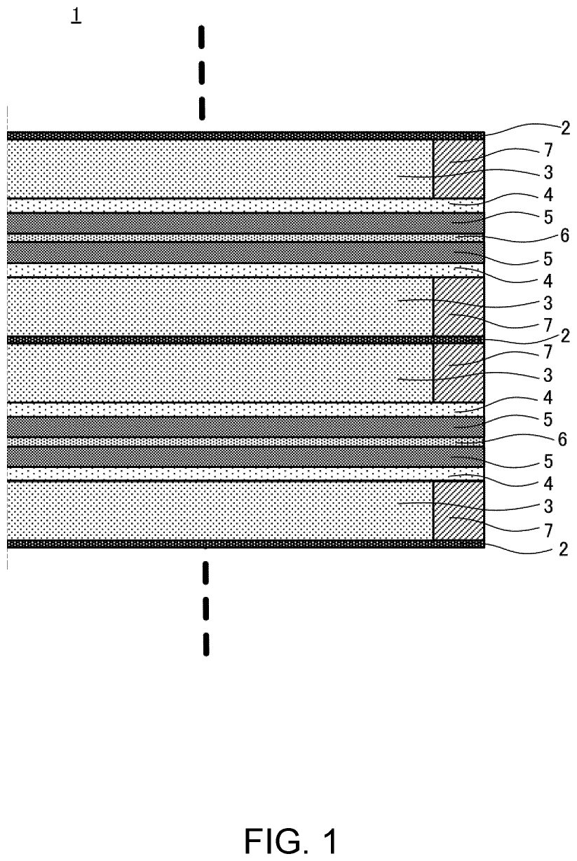

FIG. 1 is a schematic cross-sectional view illustrating a main part of an all-solid-state battery 1 according to the present embodiment. As illustrated in FIG. 1, the all-solid-state battery 1 includes a positive electrode current collector foil 2, a positive electrode active material layer 3 disposed on the positive electrode current collector foil 2, a solid electrolyte layer 4 disposed on the positive electrode active material layer 3, a negative electrode active material layer 5 disposed on the solid electrolyte layer 4, and a negative electrode current collector foil 6 disposed on the negative electrode active material layer 5. Specifically, a plurality of positive electrode current collector foils 2 and a plurality of negative electrode current collector foils 6 are alternately arranged along a laminating direction. The positive electrode active material layer 3, the solid electrolyte layer 4, and the negative electrode active material layer 5 are provided between the positive electrode current collector foil 2 and the negative electrode current collector foil 6, which are adjacent to each other in the laminating direction.

The all-solid-state battery 1 according to the present embodiment is a secondary battery that is charged and discharged by movement of lithium ions. During charging, the lithium ions move from the positive electrode active material layer 3 to the negative electrode active material layer 5 via the solid electrolyte layer 4, and lithium is occluded in the negative electrode active material layer 5. Alternatively, lithium is precipitated on the negative electrode active material layer 5. On the other hand, during discharging, the lithium ions move from the negative electrode active material layer 5 to the positive electrode active material layer 3 via the solid electrolyte layer 4, and lithium is occluded in the positive electrode active material layer 3.

The all-solid-state battery 1 according to the present embodiment may be an all-precipitation-type all-solid-state battery. The all-precipitation-type all-solid-state battery is an all-solid-state battery in which metal lithium is used as a negative electrode active material, and is a battery in which all metal lithium as a negative electrode active material is occluded in a positive electrode active material layer at the time of complete discharge. In such an all-solid-state battery, the negative electrode active material layer 5 is not present at the time of complete discharge. That is, at the time of complete discharge, the negative electrode current collector foil 6 is disposed directly on the solid electrolyte layer 4.

Here, the all-solid-state battery 1 is further provided with an insulating support frame 7. The insulating support frame 7 is disposed on the positive electrode current collector foil 2 so as to surround the positive electrode active material layer 3. The insulating support frame 7 is provided to support an end of the solid electrolyte layer 4. That is, when viewed along the laminating direction, an outer shape of the positive electrode active material layer 3 is positioned inside an outer shape of the solid electrolyte layer 4. Therefore, the end of the solid electrolyte layer 4 is not supported by the positive electrode active material layer 3. When the end of the solid electrolyte layer 4 is not supported, a defect may occur at the end of the solid electrolyte layer 4 in a pressurizing step or the like during manufacturing. In order to prevent the occurrence of such a defect, the insulating support frame 7 is provided around the positive electrode active material layer 3.

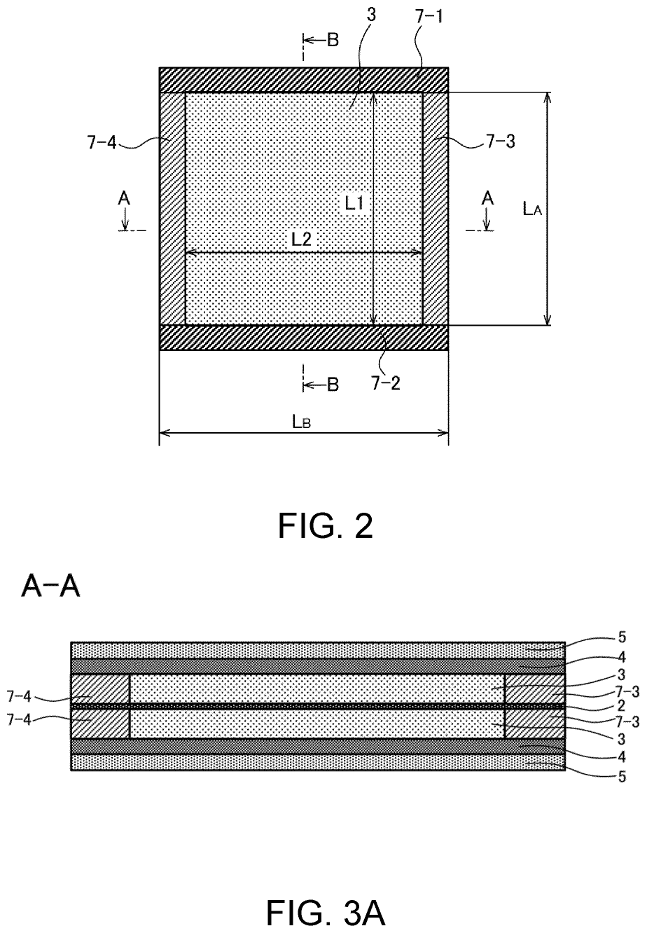

FIG. 2 is a plan view illustrating the positive electrode active material layer 3 and the insulating support frame 7. The positive electrode active material layer 3 is rectangular. Therefore, the insulating support frame 7 is also rectangular. The insulating support frame 7 has a first side 7-1, a second side 7-2, a third side 7-3, and a fourth side 7-4. The first side 7-1 and the second side 7-2 face each other, and the third side 7-3 and the fourth side 7-4 face each other. Each of the third side 7-3 and the fourth side 7-4 is also a side that connects the first side 7-1 and the second side 7-2. That is, the third side 7-3 and the fourth side 7-4 are sandwiched between the first side 7-1 and the second side 7-2. A length of the third side 7-3 and the fourth side 7-4 (L_{A} in FIG. 2) is equal to a length of the positive electrode active material layer 3 (L₁ in the figure). Further, a length (L_{B} in the figure) of the first side 7-1 and the second side 7-2 is larger than a length (L₂ in the figure) of the positive electrode active material layer 3.

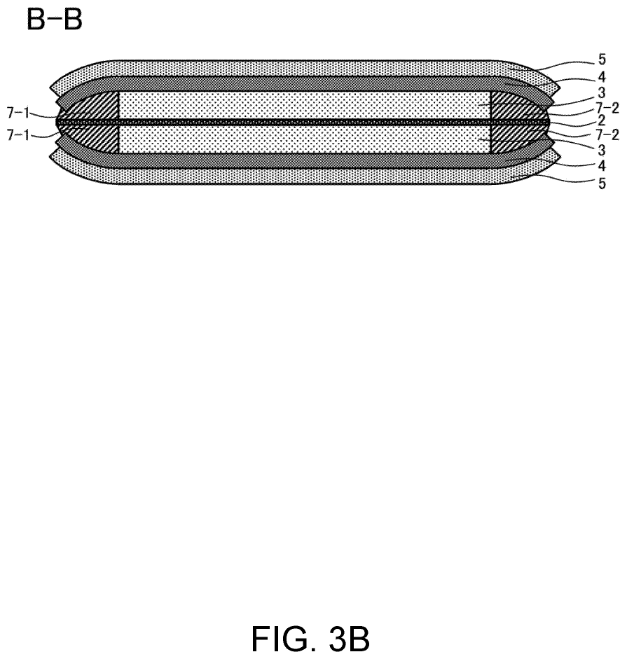

FIG. 3A is a cross-sectional view taken along a line AA of FIG. 2, and FIG. 3B is a cross-sectional view taken along a line BB in FIG. 2. As illustrated in FIG. 3B, the first side 7-1 and the second side 7-2 are each provided with an inclination. Specifically, the first side 7-1 and the second side 7-2 each have an inclination such that a thickness thereof decreases toward an outside. This inclination is an inclination formed during roll pressing. That is, the first side 7-1 and the second side 7-2 correspond to a press starting position and a press ending position during roll pressing to be described later.

Further, as illustrated in FIG. 3A, the third side 7-3 and the fourth side 7-4 are provided with almost no inclination. Inclination angles of the third side 7-3 and the fourth side 7-4 are smaller than inclination angles of the first side 7-1 and the second side 7-2. In the present specification, “the inclination angle is small” means that an angle between an outer end surface of the insulating support frame 7 and a surface of the positive electrode current collector foil 2 is close to a right angle. As illustrated in FIG. 3A, in the present embodiment, outer end surfaces of the third side 7-3 and the fourth side 7-4 are substantially perpendicular to a surface of the positive electrode current collector foil 2 and have substantially no inclination. As a result, the inclination angles of the third side 7-3 and the fourth side 7-4 are smaller than inclination angles of the first side 7-1 and the second side 7-2.

Furthermore, in the present embodiment, a Young's modulus of the first side 7-1 is smaller than Young's modulus of the third side 7-3 and the fourth side 7-4.

The above is the schematic configuration of the all-solid-state battery 1 according to the present embodiment. With such a configuration, it is possible to prevent damage and waviness caused by roll pressing. This point will be described below based on a method for manufacturing the all-solid-state battery 1.

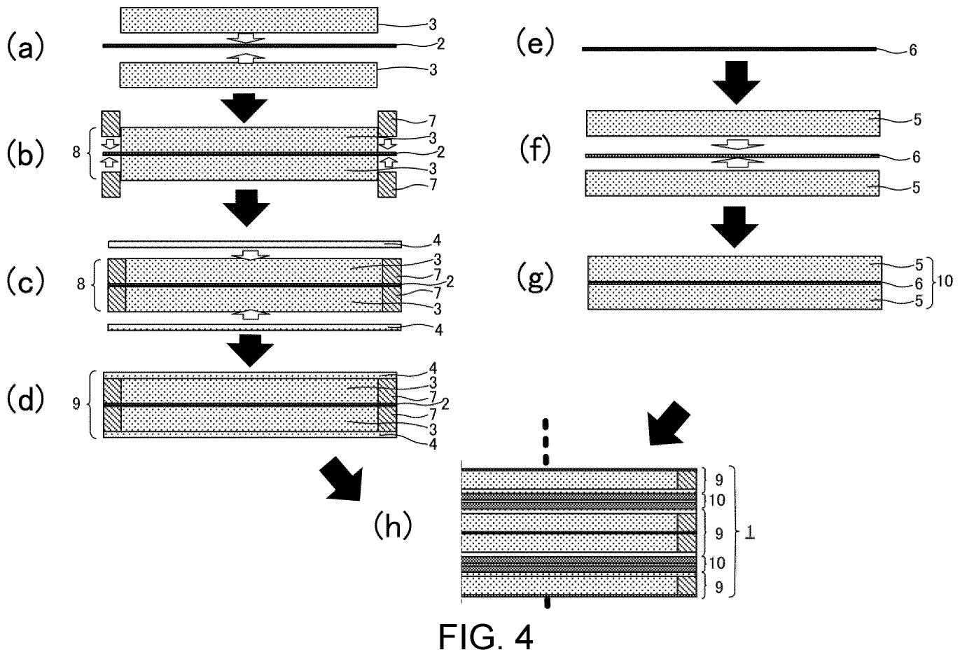

FIG. 4 is a diagram schematically illustrating a method for manufacturing the all-solid-state battery 1.

In manufacturing the all-solid-state battery 1, first, as illustrated in FIG. 4(a), the positive electrode active material layer 3 is formed on the positive electrode current collector foil 2. The positive electrode active material layer 3 can be formed by, for example, a coating method and a transfer method.

Subsequently, as illustrated in FIG. 4(b), the insulating support frame 7 is formed on the positive electrode current collector foil 2. The insulating support frame 7 can be formed, for example, by applying a slurry containing a constituent material of the insulating support frame 7 onto the positive electrode current collector foil 2. Accordingly, a positive electrode structure 8 including the positive electrode current collector foil 2, the positive electrode active material layer 3, and the insulating support frame 7 is produced.

Subsequently, as illustrated in FIG. 4(c) and (d), the solid electrolyte layer 4 is formed on the positive electrode active material layer 3 and the insulating support frame 7. The solid electrolyte layer 4 can be formed by, for example, a coating method and a transfer method. Accordingly, a positive electrode-solid electrolyte layer assembly 9 is obtained.

Further, as illustrated in FIG. 4(e), the negative electrode current collector foil 6 is prepared. As illustrated in FIG. 4(f) and (g), the negative electrode active material layer 5 is formed on the negative electrode current collector foil 6 to produce a negative electrode structure 10. When the all-precipitation-type all-solid-state battery 1 is produced, the negative electrode active material layer 5 may be omitted.

Next, as illustrated in FIG. 4(h), the positive electrode-solid electrolyte layer assembly 9 and the negative electrode structure 10 are alternately laminated. Thereafter, necessary members such as tabs are combined to obtain the all-solid-state battery 1.

The above is an outline of the entire method for manufacturing the all-solid-state battery 1. Here, in the above-described method, after the positive electrode structure 8 is produced (see FIG. 4(b)), the positive electrode structure 8 is pressed by roll pressing at least once. For example, the roll pressing is performed after the positive electrode structure 8 is produced and before the solid electrolyte layer 4 is formed. Alternatively, when the solid electrolyte layer 4 is formed by a transfer method, the roll pressing may be performed when the solid electrolyte layer 4 is transferred. Alternatively, the roll pressing may be performed after the solid electrolyte layer 4 is formed or when the positive electrode-solid electrolyte layer assembly 9 and the negative electrode structure 10 are laminated.

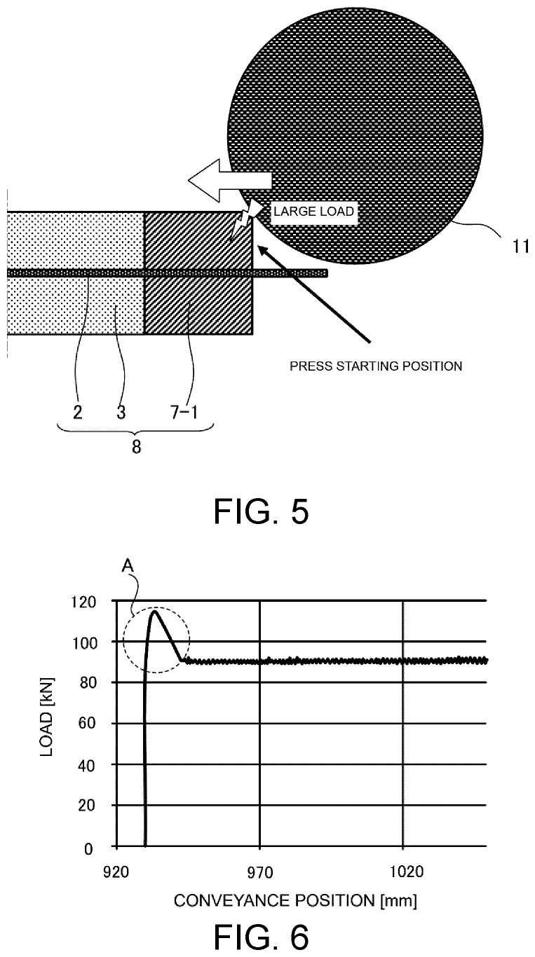

FIG. 5 is a schematic diagram illustrating a roll pressing step. As described above, the roll pressing is performed such that the pressing is started on the first side 7-1 and the pressing is ended on the second side 7-2. At this time, on the first side 7-1 which is a press starting position, a roll 11 runs up onto the first side 7-1. When the Young's modulus of the first side 7-1 is large, an excessive load is applied to the first side 7-1. FIG. 6 is a graph illustrating a relationship between a conveyance position of a workpiece and a load when the Young's modulus of the first side 7-1 is large (specifically, 175 GPa). As illustrated in FIG. 6, when the Young's modulus of the first side 7-1 is large, an excessive load is applied at the press starting position (see A in the figure). As a result, a crack is likely to occur on the first side 7-1.

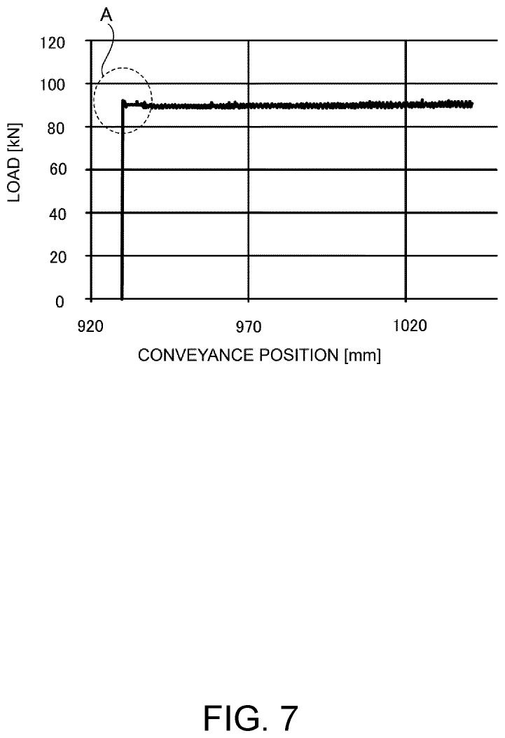

On the other hand, FIG. 7 is a graph illustrating the relationship between the conveyance position of the workpiece and the load when the Young's modulus of the first side 7-1 is small (specifically, 10 GPa). As illustrated in FIG. 7, when the Young's modulus is small, no excessive load is applied at the press starting position (see A in the figure). Therefore, since the Young's modulus of the first side 7-1 is small, the occurrence of cracks at the press starting position is suppressed. By suppressing cracks, it is possible to prevent a decrease in battery performance due to a short circuit or laminating misalignment.

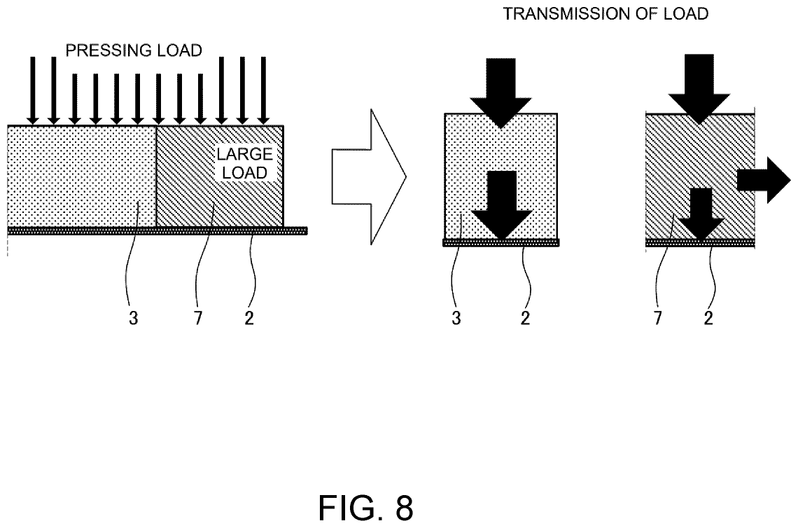

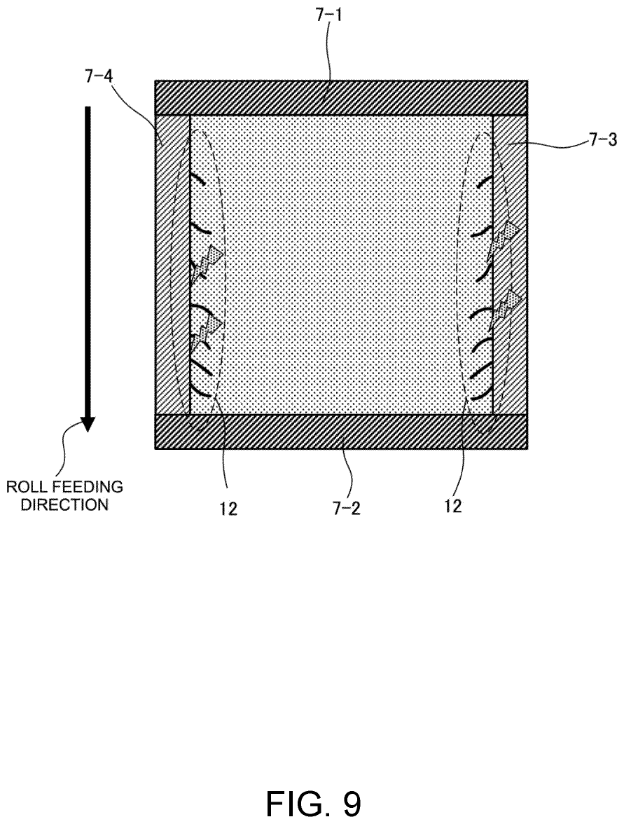

As described above, the occurrence of cracks can be suppressed by reducing the Young's modulus of the first side 7-1. However, when the Young's modulus of not only the first side 7-1 but also the third side 7-3 and the fourth side 7-4 are reduced, waviness is likely to occur during roll pressing. This point will be described with reference to FIG. 8. FIG. 8 is a schematic diagram illustrating a waviness generation mechanism. In a general all-solid-state battery, the positive electrode active material layer 3 has a large Young's modulus. When a Young's modulus of the insulating support frame 7 is reduced to the extent that the occurrence of cracks can be suppressed, a difference between a Young's modulus of the positive electrode active material layer 3 and the Young's modulus of the insulating support frame 7 increases. Due to the difference in Young's modulus, a difference occurs in the way the load is applied during roll pressing between the positive electrode active material layer 3 and the insulating support frame 7. As a result, a difference also occurs in the magnitude of the load applied to the positive electrode current collector foil 2 as a base, and a difference occurs in the way the positive electrode current collector foil 2 stretches. Accordingly, waviness occurs. FIG. 9 is a plan view illustrating a generation position of waviness 12. According to the knowledge of the present inventor, the waviness 12 due to the roll pressing is likely to occur in a roll feeding direction (direction from the first side 7-1 toward the second side 7-2). That is, the waviness 12 is likely to occur along the third side 7-3 and the fourth side 7-4.

On the other hand, in the present embodiment, the Young's modulus of the third side 7-3 and the fourth side 7-4 are set to values larger than the Young's modulus of the first side 7-1. Therefore, a difference between the Young's modulus of the positive electrode active material layer 3 and the Young's modulus of the third side 7-3 and the fourth side 7-4 is small, and a difference in load applied to the positive electrode current collector foil 2 is less likely to occur. As a result, the waviness is suppressed.

For the reasons explained above, according to the present embodiment, since the Young's modulus of the first side 7-1 is small and the Young's modulus of the third side 7-3 and the fourth side 7-4 are large, it is possible to prevent both cracks and waviness during roll pressing.

Specifically, the Young's modulus of the first side 7-1 is preferably about the same as a Young's modulus of the solid electrolyte layer 4. The Young's modulus of the solid electrolyte layer 4 is usually smaller than that of the positive electrode active material layer 3. When the Young's modulus is approximately the same as that of the solid electrolyte layer 4, an excessive load at the press starting position can be prevented. The Young's modulus of the first side 7-1 is, for example, 1 to 30 GPa.

Further, the Young's modulus of the third side 7-3 and the fourth side 7-4 are preferably equal to the Young's modulus of the positive electrode active material layer 3. Here, “equal to the Young's modulus of the positive electrode active material layer 3” means that the Young's modulus of the third side 7-3 and the fourth side 7-4 are within a range of ±5% of the Young's modulus of the positive electrode active material layer 3. The Young's modulus of the third side 7-3 and the fourth side 7-4 are, for example, 50 to 300 GPa.

A Young's modulus of the second side 7-2 corresponding to a press ending position is not particularly limited.

From one viewpoint, the Young's modulus of the second side 7-2 is preferably smaller than the Young's modulus of the third side 7-3 and the fourth side 7-4, similarly to the first side 7-1. More preferably, the Young's modulus of the second side is the same as the Young's modulus of the first side 7-1. By adopting such a configuration, a difference in an amount of compression between the first side 7-1 and the second side 7-2 during roll pressing can be reduced, and a difference in a film thickness between the first side 7-1 and the second side 7-2 can be reduced. Accordingly, when the solid electrolyte layer 4 is formed by transfer, a transfer failure is less likely to occur. When the solid electrolyte layer 4 is formed by a coating method, coating accuracy can be improved, and a difference in adhesion between the solid electrolyte layer 4 and the insulating support frame 7 can be prevented.

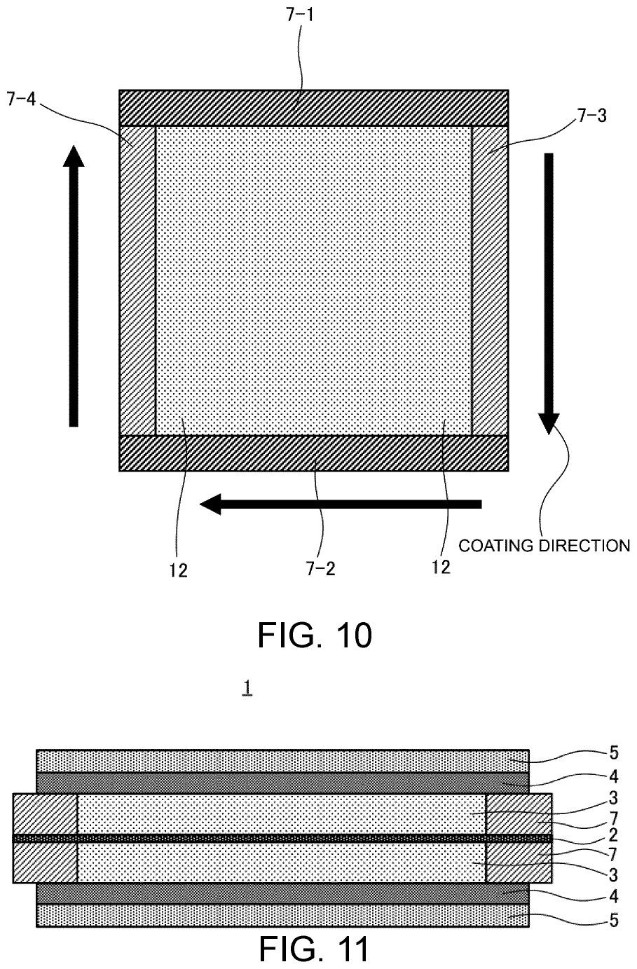

Further, from another viewpoint, the second side 7-2 preferably has the same composition as the third side 7-3 and the fourth side 7-4. That is, the Young's modulus of the second side 7-2 is preferably the same as the Young's modulus of the third side 7-3 and the fourth side 7-4. With such a configuration, the insulating support frame 7 can be easily produced. This point will be described with reference to FIG. 10. FIG. 10 is a schematic diagram illustrating an example of a step of producing the insulating support frame 7. The insulating support frame 7 can be formed, for example, by applying a slurry containing the constituent material of the insulating support frame 7 with a dispenser or the like. At this time, when the second side 7-2, the third side 7-3, and the fourth side 7-4 have the same composition, the second side 7-2, the third side 7-3, and the fourth side 7-4 can be continuously coated. As a result, a manufacturing process can be simplified.

Next, details of the insulating support frame 7 will be described.

The insulating support frame 7 preferably has an electrical resistivity of 10⁵ Ωcm or more. More preferably, the electrical resistivity of the insulating support frame 7 is 10⁶ Ωcm or more. When the insulating support frame 7 has such an electrical resistivity, an electrode reaction (transfer of lithium ions) is uniformly performed at an interface between the positive electrode active material layer 3 and the solid electrolyte layer 4. In addition, a short circuit between positive and negative electrodes is more reliably prevented.

A width of the insulating support frame 7 is not particularly limited, but is, for example, 1 to 30 mm, and preferably 1 to 10 mm.

In the insulating support frame 7, a clearance is preferably zero at a portion where the sides are connected to each other. That is, it is preferable that no gap is formed between the sides.

The clearance between the insulating support frame 7 and the positive electrode active material layer 3 is preferably zero. That is, the insulating support frame 7 is preferably disposed to be in contact with an outer peripheral end surface of the positive electrode active material layer 3.

A thickness of the insulating support frame 7 is preferably the same as a thickness of the positive electrode active material layer 3 except for inclined portions of the first side 7-1 and the second side 7-2. The thickness of the insulating support frame 7 is, for example, 30 to 1000 μm, and preferably 30 to 100 μm.

The constituent material of the insulating support frame 7 is not particularly limited as long as the material is insulating. The insulating support frame 7 can be formed of, for example, an insulating polymer, an ion-conductive polymer, an insulating inorganic substance, an oxide-based solid electrolyte, a sulfide-based solid electrolyte, or the like.

However, when the solid electrolyte layer 4 contains a sulfide solid electrolyte, the insulating support frame 7 is preferably formed of a material dispersible in a low-polarity solvent. When the positive electrode structure 8 is produced, the insulating support frame 7 is preferably formed by dispersing a material for forming the insulating support frame 7 in a low-polarity solvent to prepare an insulating support frame slurry, and applying the prepared insulating support frame slurry onto the positive electrode current collector foil 2. When the solid electrolyte layer 4 contains a sulfide solid electrolyte, a residue of the solvent used in manufacturing the insulating support frame 7 may react with the sulfide solid electrolyte. However, the low-polarity solvent hardly reacts with the sulfide solid electrolyte. Therefore, by using the low-polarity solvent, the reaction between the sulfide solid electrolyte and the residual solvent can be prevented. Accordingly, insulation properties of the solid electrolyte layer 4 are ensured, and dendrites can be suppressed. Examples of the low-polarity solvent include trimethylbenzene, dimethylbenzene, and butyl acetate.

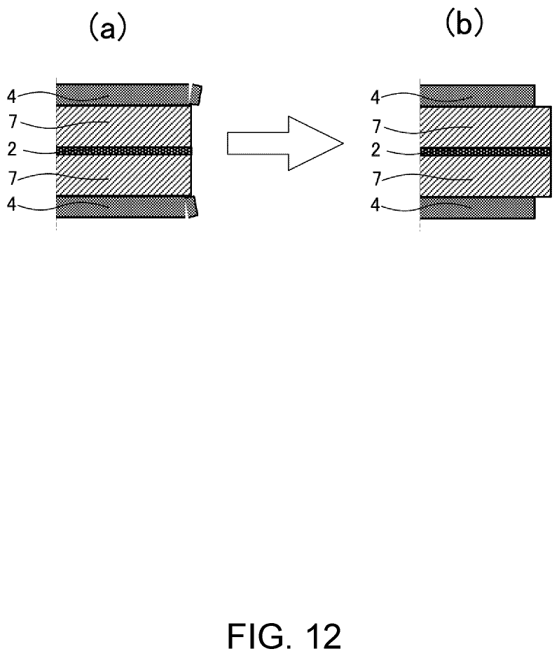

Next, a modification related to a position of an end of the insulating support frame 7 will be described. FIG. 11 is a schematic cross-sectional view illustrating this modification. In this modification, when viewed along the laminating direction, the end of the insulating support frame 7 is located outside the end of the solid electrolyte layer 4. With such a configuration, it is possible to suppress the end of the solid electrolyte layer 4 from slipping off. FIG. 12 is a schematic diagram illustrating a slipping mechanism of the end of the solid electrolyte layer 4. FIG. 12(a) is a diagram of a case where the position of the end of the insulating support frame 7 is aligned with a position of the end of the solid electrolyte layer 4. In the case of the example illustrated in FIG. 12(a), when the solid electrolyte layer 4 is stretched under a roll-pressing pressure, the end of the solid electrolyte layer 4 protrudes outward beyond the end of the insulating support frame 7. As a result, the end of the solid electrolyte layer 4 is not supported and is prone to slipping off. Slipping of the end should be avoided because the slipping causes contamination and short circuits. Further, as illustrated in FIG. 12(b), when the end of the insulating support frame 7 is located outside the end of the solid electrolyte layer 4, the end of the solid electrolyte layer 4 is still supported by the insulating support frame 7 even if the solid electrolyte layer 4 stretches to some extent. Therefore, the end of the solid electrolyte layer 4 is prevented from slipping off.

In this modification, the position of the end of the insulating support frame 7 is preferably located outside the end of the solid electrolyte layer 4 in all of the first side 7-1 to the fourth side 7-4. However, on at least one side of the first side 7-1 to the fourth side 7-4, the end of the insulating support frame 7 may be located outside the end of the solid electrolyte layer 4. Even in such a case, since it is possible to prevent the end of the solid electrolyte layer 4 from slipping off on the at least one side, a certain effect is achieved.

Next, configurations other than the insulating support frame 7 will be described.

The material of the solid electrolyte layer 4 is not particularly limited as long as the material is a solid and functions as an electrolyte layer in a secondary battery. The solid electrolyte layer 4 includes, for example, a resin binder and a solid electrolyte dispersed in the resin binder. The solid electrolyte preferably includes a sulfide solid electrolyte. A thickness of the solid electrolyte layer 4 is, for example, 5 to 100 μm.

The positive electrode active material layer 3 may be formed of a material capable of releasing lithium ions during charging and occluding lithium ions during discharging. The positive electrode active material layer 3 is formed of, for example, a material including a resin binder and a positive electrode active material dispersed in the resin binder. The positive electrode active material is not particularly limited, and for example, an NMC positive electrode active material or the like can be used. The thickness of the positive electrode active material layer 3 is, for example, 30 to 1000 μm, and preferably 10 to 500 μm.

As the positive electrode current collector foil 2, for example, a metal foil is used. As the positive electrode current collector foil 2, for example, an aluminum foil can be used. A thickness of the positive electrode current collector foil 2 is, for example, 5 to 50 μm, and preferably 8 to 20 μm.

As the negative electrode current collector foil 6, for example, a metal foil is also used. As the negative electrode current collector foil 6, for example, SUS and a copper foil can be used. A thickness of the negative electrode current collector foil 6 is, for example, 5 to 50 μm, and preferably 8 to 20 μm.

The embodiment and modifications of the present disclosure have been described above. The relationship between the configuration and the effects of the present invention will be summarized below.

In one aspect, the all-solid-state battery 1 includes: the positive electrode current collector foil 2; the positive electrode active material layer 3 disposed on the positive electrode current collector foil 2; the solid electrolyte layer 4 disposed on the positive electrode active material layer 3; the negative electrode active material layer 5 or the negative electrode current collector foil 6 disposed on the solid electrolyte layer 4; and the insulating support frame 7 disposed on the positive electrode current collector foil 2 so as to surround the positive electrode active material layer 3. The insulating support frame 7 has the first side 7-1 and the second side 7-2 facing each other, the first side 7-1 and the second side 7-2 each having an inclination such that a thickness thereof decreases toward an outside, and the third side 7-3 and the fourth side 7-4 each configured to connect the first side 7-1 and the second side 7-2, the third side 7-3 and the fourth side 7-4 having a smaller inclination angle than the first side 7-1 and the second side 7-2. A Young's modulus of the first side 7-1 is smaller than Young's modulus of the third side 7-3 and the fourth side 7-4. With such a configuration, since the Young's modulus of the first side 7-1 is small, it is possible to prevent an excessive load from being applied at the press starting position during roll pressing, and to suppress the occurrence of cracks. In addition, since the Young's modulus of the third side 7-3 and the fourth side 7-4 are large, the occurrence of waviness can be suppressed.

From one viewpoint, the Young's modulus of the second side 7-2 is preferably smaller than the Young's modulus of the third side 7-3 and the fourth side 7-4. With such a configuration, the Young's modulus of the first side 7-1 and the second side 7-2 can be made approximately the same. As a result, a difference in a film thickness between the first side 7-1 and the second side 7-2 can be reduced. Accordingly, it is easy to form the solid electrolyte layer 4 with high reliability.

From another viewpoint, the second side 7-2, the third side 7-3, and the fourth side 7-4 preferably have the same composition. With this configuration, the second side 7-2 to the fourth side 7-4 can be continuously produced, and a manufacturing process can be simplified.

Preferably, the Young's modulus of the third side 7-3 and the fourth side 7-4 are equal to the Young's modulus of the positive electrode active material layer 3. With this configuration, the occurrence of waviness can be more reliably prevented.

Preferably, on at least one side of the first side 7-1 to the fourth side 7-4, an end of the insulating support frame 7 is located outside the end of the solid electrolyte layer 4. With this configuration, it is possible to more reliably prevent the end of the solid electrolyte layer 4 from slipping off.

Preferably, an electrical resistivity of the insulating support frame 7 is 10⁵ Ωcm or more. With this configuration, an electrode reaction (transfer of lithium ions) is uniformly performed at an interface between the positive electrode active material layer 3 and the solid electrolyte layer 4, and a short circuit between positive and negative electrodes is more reliably prevented.

Preferably, the solid electrolyte layer 4 includes a sulfide solid electrolyte. The insulating support frame 7 is formed of a material dispersible in a low-polarity solvent. With this configuration, the insulating support frame 7 can be formed using a low-polarity solvent. As a result, the reaction between the sulfide solid electrolyte and the residue of the solvent used in forming the insulating support frame 7 can be suppressed.

In one aspect, a method for manufacturing the all-solid-state battery 1 includes: a step of forming the positive electrode active material layer 3 on the positive electrode current collector foil 2; a step of forming the insulating support frame 7 surrounding the positive electrode active material layer 3 on the positive electrode current collector foil 2 to produce the positive electrode structure 8 including the positive electrode current collector foil 2, the positive electrode active material layer 3, and the insulating support frame 7; and a step of pressing the positive electrode structure 8 by roll pressing. The insulating support frame 7 has the first side 7-1 and the second side 7-2 facing each other, and the third side 7-3 and the fourth side 7-4 each configured to connect the first side 7-1 and the second side 7-2. A Young's modulus of the first side 7-1 is smaller than Young's modulus of the third side 7-3 and the fourth side 7-4. The pressing step includes a step of performing roll pressing such that pressing is started on the first side 7-1 and the pressing is ended on the second side 7-2. According to such a method, since the Young's modulus of the first side 7-1 is small, it is possible to prevent an excessive load from being applied at the press starting position during roll pressing, and to suppress the occurrence of cracks. In addition, since the Young's modulus of the third side 7-3 and the fourth side 7-4 are large, the occurrence of waviness can be suppressed.

Preferably, the method for manufacturing the all-solid-state battery 1 further includes: a step of forming the solid electrolyte layer 4 on the positive electrode active material layer 3; and a step of forming the negative electrode active material layer 5 or the negative electrode current collector foil 6 on the solid electrolyte layer 4.

Preferably, the solid electrolyte layer 4 includes a sulfide solid electrolyte. The step of producing the positive electrode structure 8 includes a step of dispersing a material for forming the insulating support frame 7 in a low-polarity solvent to prepare an insulating support frame slurry, and a step of forming the insulating support frame 7 by applying the insulating support frame slurry onto the positive electrode current collector foil 2. According to this method, the residue of the solvent used in forming the insulating support frame 7 can be suppressed from reacting with the sulfide solid electrolyte.

1. An all-solid-state battery comprising:
a positive electrode current collector foil;
a positive electrode active material layer disposed on the positive electrode current collector foil;
a solid electrolyte layer disposed on the positive electrode active material layer;
a negative electrode active material layer or a negative electrode current collector foil disposed on the solid electrolyte layer; and
an insulating support frame disposed on the positive electrode current collector foil so as to surround the positive electrode active material layer, wherein
the insulating support frame has
a first side and a second side facing each other, the first side and the second side each having an inclination such that a thickness thereof decreases toward an outside, and
a third side and a fourth side each configured to connect the first side and the second side, the third side and the fourth side having a smaller inclination angle than the first side and the second side, and
a Young's modulus of the first side is smaller than Young's modulus of the third side and the fourth side.

2. The all-solid-state battery according to claim 1, wherein
a Young's modulus of the second side is smaller than the Young's modulus of the third side and the fourth side.

3. The all-solid-state battery according to claim 1, wherein
the second side, the third side, and the fourth side have the same composition.

4. The all-solid-state battery according to claim 1, wherein
the Young's modulus of the third side and the fourth side are equal to a Young's modulus of the positive electrode active material layer.

5. The all-solid-state battery according to claim 1, wherein
on at least one side of the first side to the fourth side, an end of the insulating support frame is located outside an end of the solid electrolyte layer.

6. The all-solid-state battery according to claim 1, wherein
an electrical resistivity of the insulating support frame is 10⁵ Ωcm or more.

7. The all-solid-state battery according to claim 1, wherein
the solid electrolyte layer includes a sulfide solid electrolyte, and
the insulating support frame is formed of a material dispersible in a low-polarity solvent.

8. A method for manufacturing an all-solid-state battery, the method comprising:
a step of forming a positive electrode active material layer on a positive electrode current collector foil;
a step of forming an insulating support frame surrounding the positive electrode active material layer on the positive electrode current collector foil to produce a positive electrode structure including the positive electrode current collector foil, the positive electrode active material layer, and the insulating support frame; and
a step of pressing the positive electrode structure by roll pressing, wherein
the insulating support frame has
a first side and a second side facing each other, and
a third side and a fourth side each configured to connect the first side and the second side,
a Young's modulus of the first side is smaller than Young's modulus of the third side and the fourth side, and
the pressing step includes a step of performing roll pressing such that pressing is started on the first side and the pressing is ended on the second side.

9. The manufacturing method according to claim 8, further comprising:
a step of forming a solid electrolyte layer on the positive electrode active material layer; and
a step of forming a negative electrode active material layer or a negative electrode current collector foil on the solid electrolyte layer.

10. The manufacturing method according to claim 9, wherein
the solid electrolyte layer includes a sulfide solid electrolyte, and
the step of producing the positive electrode structure includes
a step of dispersing a material for forming the insulating support frame in a low-polarity solvent to prepare an insulating support frame slurry, and
a step of forming the insulating support frame by applying the insulating support frame slurry onto the positive electrode current collector foil.
